(19) United States
(12) Patent Application Publication
(10) Pub. No.: US 2010/0077429 A1
(43) Pub. Date: Mar. 25, 2010

(54) SYSTEM AND METHOD FOR PROVIDING MULTIMEDIA SERVICE

(75) Inventors: Jung Tae KIM, Daejeon (KR); Sang Wook PARK, Daejeon (KR); Jong Hoon LEE, Daejeon (KR); Eui Hyun PAIK, Daejeon (KR); Kwang Roh PARK, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/234,288

(22) Filed: Sep. 19, 2008

(51) Int. Cl. G06F 13/10; G06F 13/00

(52) U.S. Cl. 725/37; 340/572.1

(57) ABSTRACT

The present invention relates to a system and method for providing a multimedia service, which support event based home network service mobility through a Radio Frequency Identification (RFID) tag. The system for providing a multimedia service, includes a RFID tag, and a home server for performing a login authentication operation using RFID tag information provided from the RFID tag, storing service usage information of a multimedia service provided for a login user, and providing a corresponding multimedia service based on the service usage information of the multimedia service when a multimedia service is requested again.

### CROSS-REFERENCE TO RELATED APPLICATION

This application claims the benefit of Korean Application No. 2007-0129478, filed on Dec. 12, 2007 in the Korean Intellectual Property Office, the disclosure of which is incorporated herein by reference.

### BACKGROUND OF THE INVENTION

1. Field of the Invention

The present invention relates to a system and method for providing a multimedia service, which support event based home network service mobility through a Radio Frequency Identification (RFID) tag.

2. Description of the Related Art

Ubiquitous paradigm was introduced to provide optimized services to a user at anywhere and anytime in a home network environment using various devices disposed around the user. In order to realize the ubiquitous paradigm, ubiquitous computing environment has been developed. Accordingly, there is a demand for developing a method for stably providing a service in such ubiquitous computing environment in consideration of diverse situations of a user and service characteristics without making a user annoying.

A home network system according to the related art includes a Universal Plug and Play (UPnP) based Internet Protocol (IP) settop box to support multimedia service sharing. However, such a home network system requires the UPnP based IP settop box and a personal computer (PC) to employ UPnP standard technology and also requires additional operations for supporting mobility of a multimedia stream service such as Video on Demand (Vod) that is transmitted in real time.

As another exemplary service for ubiquitous computing environment, a Location Based Service LBS was introduced. The LBS is provided by recognizing and identifying a user using a Radio Frequency Identification (RFID) tag. However, an event based multimedia service without user interaction was not provided. Therefore, many researches have been actively progressed to develop a method for providing an event based multimedia service without user interaction by dynamically managing users by a RFID tag with a home network system and storing and sharing multimedia service information according to a request of each user.

### SUMMARY OF THE INVENTION

The present invention provides a system and method for providing a multimedia service to embody a function for managing users and services and to support an event based service mobility through a RFID tag in a Linux based home server.

In accordance with an aspect of the present invention, there is provided a system for providing a multimedia service including a RFID tag and a home server. The home server performs a login authentication operation using RFID tag information provided from the RFID tag, stores service usage information of a multimedia service provided for a login user, and provides a corresponding multimedia service based on the service usage information of the multimedia service when a multimedia service is requested again.

The system may further include a relaying server for accessing the home server through a network, receiving a predetermined multimedia service from the home server, and providing the predetermined multimedia service.

In accordance with another aspect of the present invention, there is provided a method for providing a multimedia service. In the method, predetermined Radio Frequency Identification (RFID) tag information is received from a RFID tag. A login authentication operation is performed for a corresponding user based on the received RFID tag information. Service usage information of a multimedia service is detected using user information of a login user when the login user requests the multimedia service. Then, a corresponding multimedia service is provided based on the detected service usage information of the multimedia service.

In accordance with another aspect of the present invention, there is provided a method for providing a multimedia service. In the method, RFID tag information is received from a relaying server connected through a network. A login authentication operation is performed for a corresponding user based on the received RFID tag information. Then, user information of a login user and corresponding service usage information are provided to the relaying server and a multimedia service requested according to the service usage information is provided.

### BRIEF DESCRIPTION OF THE DRAWINGS

FIG. 1 is a diagram illustrating a system for providing a multimedia service in accordance with an exemplary embodiment of the present invention.

FIGS. 2 and 3 are block diagrams illustrating a system for providing a multimedia service in accordance with an embodiment of the present invention.

FIG. 4 is a diagram for describing operations of a system for providing a multimedia service in accordance with an embodiment of the present invention.

FIG. 5 is a diagram illustrating an internal structure of a home server in accordance with an embodiment of the present invention.

FIG. 6 is a diagram illustrating various configurations of a system for providing a multimedia service in accordance with another embodiment of the present invention.

FIG. 7 is a diagram for describing operations of a system for providing a multimedia service shown in FIG. 6.

FIG. 8 is a flowchart illustrating a method for providing a multimedia service in accordance with an embodiment of the present invention.

FIG. 9 is a flowchart illustrating a method for providing a multimedia service in accordance with another embodiment of the present invention.

### DETAILED DESCRIPTION OF THE PREFERRED EMBODIMENTS

The advantages, features and aspects of the invention will become apparent from the following description of embodiments with reference to the accompanying drawings.

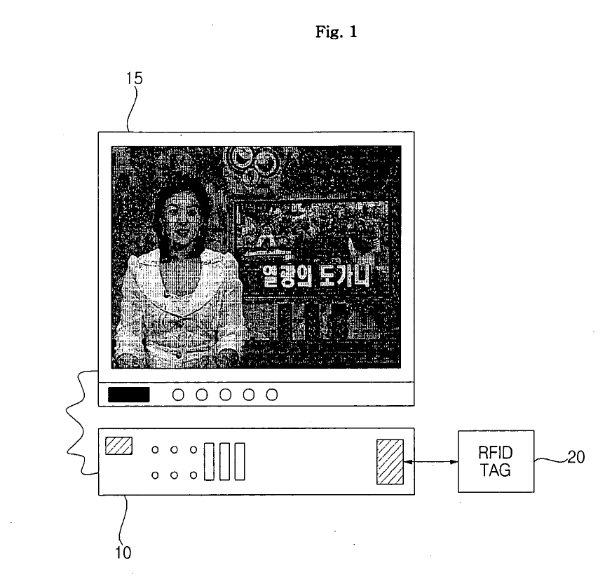

FIG. 1 is a diagram illustrating a system for providing a multimedia service in accordance with an exemplary embodiment of the present invention. Referring to FIG. 1, the multimedia service providing system according to the present embodiment includes a home server 10 for storing a plurality of services and providing a predetermined requested service and a Radio Frequency Identification (RFID) 20 for providing authentication information by accessing the home server 10 for login authentication of a user

The RFID tag 20 transmits predetermined information to the home server 10 when the RFID tag 20 accesses and communicates with the home server 10. The RFID tag 20 may be independently provided, or may be internally or externally disposed at a mobile terminal capable of communication.

The home server 10 stores user authentication information for login authentication and home server accessing information according to RFID tag information of the accessed RFID tag. The home server 10 performs login authentication for a registered user using the received predetermined information from the RFID tag 20. The home server 10 may be embodied as a settop-box or a personal computer (PC), and a communication protocol is provided for communication between the home server 10 and the RFID tag 20.

The home server 10 includes a display unit 15 for outputting a requested multimedia service among the plurality of stored multimedia services. The display unit 15 may be independently provided from the home server 10. In this case, the display unit 15 may be connected to the home server 10 based on wired or wireless communication method. For example, the settop box is connected to a television set, and the television set displays a multimedia service provided through the settop box.

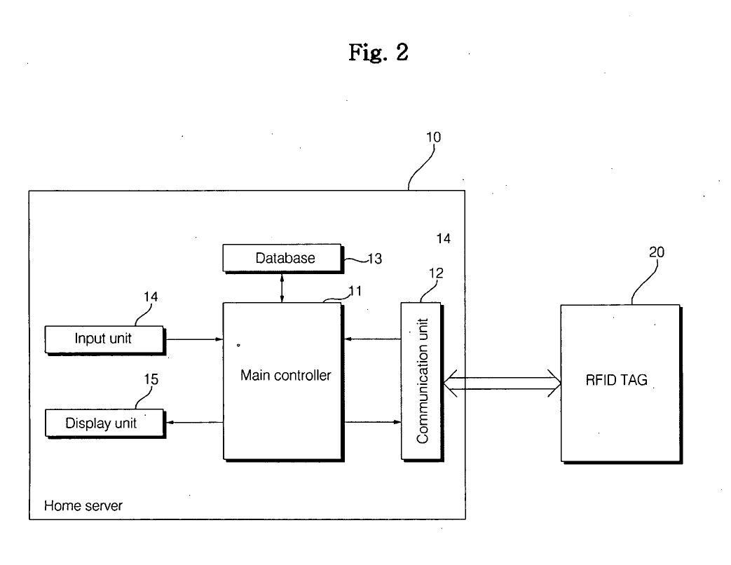

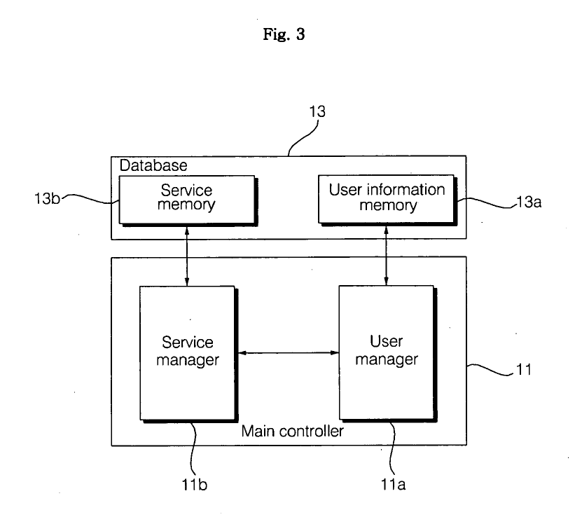

Hereinafter, a structure of the system for providing a multimedia service according to an embodiment of the present invention will be described with reference to FIGS. 2 and 3.

FIGS. 2 and 3 are block diagrams illustrating a system for providing a multimedia service in accordance with an embodiment of the present invention. Referring to FIGS. 2 and 3, the home server 10 includes a communication unit 12, a database 13, and a main controller 11 for controlling the communication unit 12 and the database 13. The home server 10 further includes an input unit 13 for receiving predetermined control commands and a display unit 15 for displaying outputs for a requested service.

The communication unit 12 provides a communication protocol for communicating with and accessing the RFID tag 20 and another home server. The data base 13 stores a plurality of multimedia services and user information for providing the plurality of multimedia services.

The database 13 includes a service memory 13b for storing a plurality of multimedia services and a user information memory 13a for storing user information of registered users in order to provide the plurality of stored multimedia services in the service memory 13b.

The user information memory 13a stores user information including login authentication information for each user and corresponding service usage information. Herein, the service usage information includes information on a usage history of a multimedia service provided to a login user, playback information of each multimedia service, and service time information of using each multimedia service.

The main controller 10 includes a user manager 11a for managing the user information stored in the user memory 13a and a service manager 11b for managing the plurality of multimedia services stored in the server memory 13b.

The user manager 11a performs a login authentication operation for a user based on information received from the RFID tag 20. The service manager 11b performs operations for providing a predetermined multimedia service stored in the service memory 13b based on user information sensed through the user manager 11a and corresponding service usage information. Here, the service manager 11b senses service usage information based on the user information stored in the user information memory 13a and provides a multimedia service of a predetermined location or a predetermined time based on the sensed service usage information.

When the service manager 11b receives a request of terminating a current service from a login user, the service manager 11b stores service usage information provided to the login user, such as playback information and service time information of the provided service, in the user information memory 13a and performs control operation to terminate the service. Here, the user manager 11a manages service usage information for the multimedia service provided to the login user.

If a user accesses and communicates with the home service using a RFID tag 20 storing the same login authentication information and requests a multimedia service that was previously requested before, the service manager 11b detects service usage information stored in the user information memory 13a. Here, the service manager 11b provides a multimedia service from the previously provided multimedia service by sensing the detected playback information and service time information.

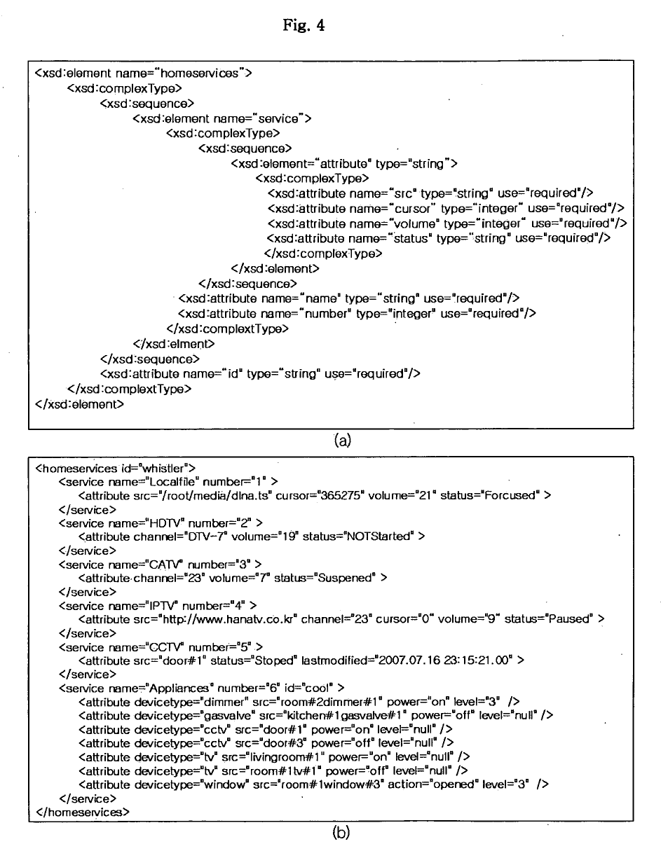

FIG. 4 is a diagram for describing operations of a system for providing a multimedia service in accordance with an embodiment of the present invention. That is, an example of embodying data provided through the home service is shown in FIG. 4.

At first, a diagram a) of FIG. 4 shows metadata for service usage information of each user stored in the user information memory 13a, and a diagram b) of FIG. 4 shows metadata for a multimedia service provided to a user.

As shown in FIG. 4, the service usage information is provided based on eXtensible Markup Language (XML) and includes detail properties such as user identification information, information on a location of providing a multimedia service, a cursor, and volume, and service state information.

Therefore, it is possible to provide a multimedia service with the same condition of a previously provided service when a next service is requested. Here, the service usage information may be provided as information or metadata for broadcasting services such as terrestrial cable IP TV or a control service for home appliances.

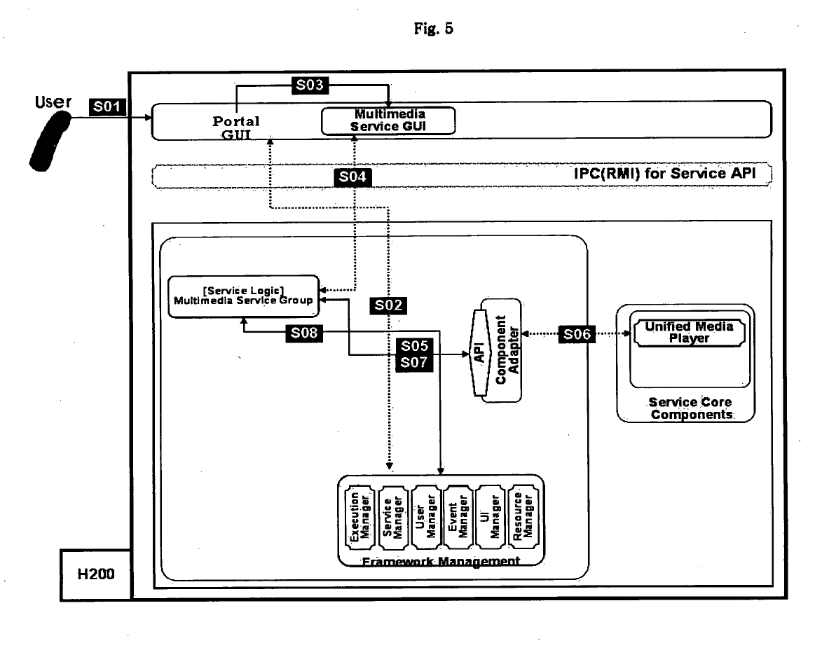

FIG. 5 is a diagram illustrating an internal structure of a home server for describing the operations thereof in accordance with an embodiment of the present invention. Hereinafter, operations of constituent elements of the home server will be described in detail with reference to FIG. 5.

At first, when a RFID tag 20 accesses a home server 10 as a user moves, a service request is transferred to a Portal Graphic User Interface (GUI) at step S01. Here, service request confirmation is transmitted to a Service Manager (SM) in Framework Management (FM), which is a major function in the home server 10, at step S02. As a response thereof, a multimedia service User Interface (UI) of a multimedia service selected by a user is driven at step S03.

When the multimedia service is provided at step S04, a user controls hardware of the home server 10 through a service execution request at steps S05 and S06. If the multimedia service requested by a user is successfully driven, a service state is registered at the FM through a confirmation message at step S07.

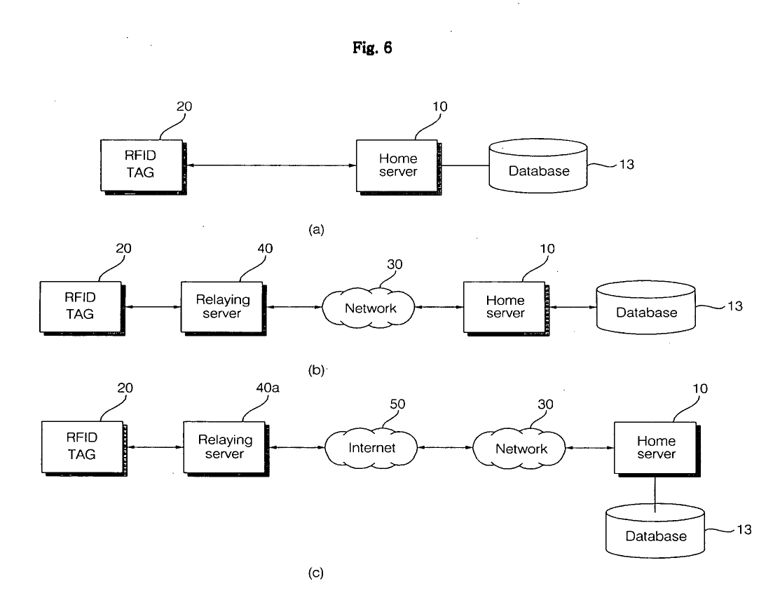

FIG. 6 is a diagram illustrating various configurations of a system for providing a multimedia service in accordance with another embodiment of the present invention. The multimedia service providing system according to the present embodiment may have various configurations according to connection formations.

As shown in a diagram a) of FIG. 6, the RFID tag 20 may be directly connected to the home server 10 in the multimedia service providing system according to the present embodiment. As shown in a diagram b) of FIG. 6, a relaying service 40 in a home network 30 is used to access the home server 10 in the multimedia service providing system according to the present embodiment. As shown in a diagram c) of FIG. 6, an external relaying server 40a, which is connected to the Internet 50, is used to access the home server 10 in the home network 40 in the multimedia service providing system according to the present invention.

In case of the diagrams b) and c) of FIG. 6, the relaying server 40 may be another home server or a personal computer (PC). Here, the relaying server 40 receives user login authentication information and home server accessing information from the RFID tag 20. Therefore, the relaying server 40 can access the home server 10 through the home network 30 or the Internet 50.

The relaying server 490 performs the login authentication operation by transmitting the user login information to the home server 10. After performing the user login authentication, the home server 10 sets up the user information memory 13a and the service memory 13b to be shared with the relaying server 40, thereby providing a corresponding multimedia service through the relaying server 40. That is, the relaying server 40 outputs a predetermined multimedia service menu provided from the home server 10 through the display unit 15.

If a predetermined multimedia service is requested through the provided multimedia service menu displayed on the display unit 15, the relaying server 40 detects a corresponding multimedia service based on service usage information stored in the home server 10 and outputs the detected multimedia service through the display unit 15.

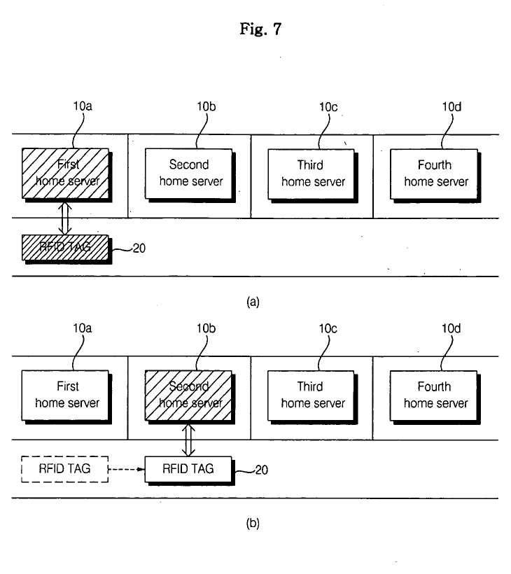

FIG. 7 is a diagram for describing operations of a system for providing a multimedia service shown in FIG. 6.

As shown in a diagram a) of FIG. 7, when the RFID tag 20 accesses a first home server 10a, the RFID tag 20 receives a predetermined multimedia service from the first home server 10a.

As shown in a diagram b) of FIG. 7, where the RFID tag 20 moves, the first home server 10a ends the multimedia service provided to a login user by the RFID tag 20 and performs a logout operation. Here, service usage information of the multimedia service provided to the login user is stored.

Meanwhile, the RFID tag 20 tries accessing a second home server 10b as the RFID tag 20 moves to the second home server 10b. Here, the second home server 10b performs login authentication of a user by receiving user information from the first home server 10a where the RFID tag information is registered, and provides a predetermined service according to a request from a login user based on the service usage information stored in the first home server 10a.

Likewise, if the RFID tag 20 moves to a third home server 10c or a fourth home server 10d, connection to the accessed home server is terminated, and a multimedia service is provided through re-login to the new home server at the moved location.

Here, the first home server 10a to fourth home server 10d are previously setup to share information with each other. That is, user information and service usage information are only shared with the previously setup home servers. However, the present invention is not limited thereto. The information may be shared with another home server through additional authentication procedures.

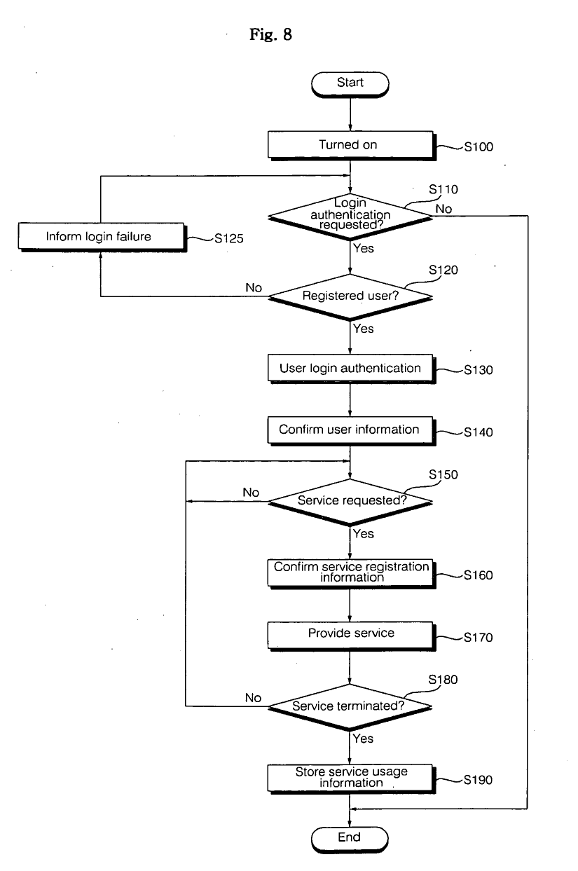

FIG. 8 is a flowchart illustrating a method for providing a multimedia service in accordance with an embodiment of the present invention.

Referring to FIG. 8, a RFID tag 20 accesses a home server 10 at step S100. If a main controller 11 of a home server 10 receives a login authentication request for a predetermined user as receiving RFID tag information from the RFID tag 20 at step S110, the main controller 11 of a home server 10 determines whether user authentication information included in received RFID tag information is login authentication information of previously registered user or not at step S120. If it is not the login authentication information of the previously registered user, the main controller 10 outputs a message informing login failure at step S125.

On the contrary, if it is the login authentication information of the previously registered user at step S120, the main controller 11 performs a login authentication operation for a corresponding user at step S130. Here, the main controller 11 provides a service menu at step 140 after sensing user information of the login user.

If the login user requests a predetermined service through the service menu from the login use at step S150, the main controller 11 senses playback information or using service time information of the corresponding multimedia service by detecting service usage information for the requested service at step S160. Therefore, the main controller 11 provides a corresponding service based on the sensed service usage information at step S170.

Meanwhile, if a login user requests service termination at step S180, the main controller 11 stores service usage information for the provided service at step S190, and terminates the service.

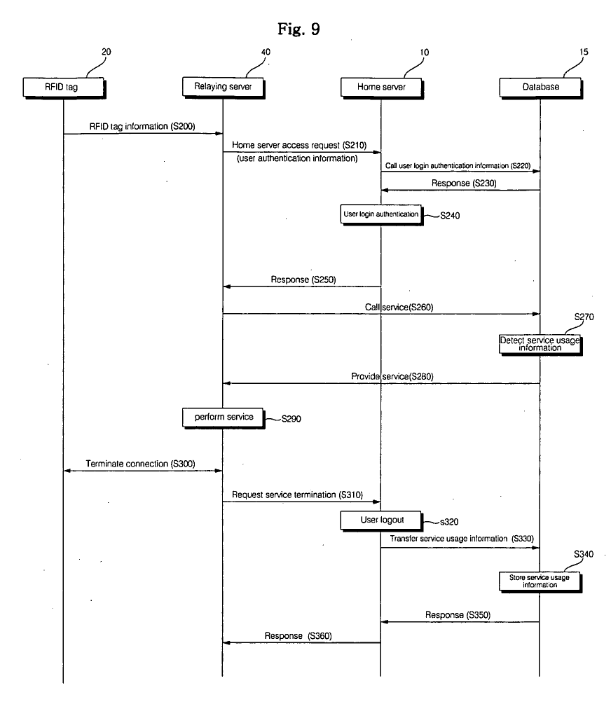

FIG. 9 is a flowchart illustrating a method for providing a multimedia service in accordance with another embodiment of the present invention. FIG. 9 shows operation flow of the multimedia service providing system having the configuration shown in the diagram b) of FIG. 6.

Referring to FIG. 9, a RFID tag 20 requests accessing a home server 10 by transmitting RFID tag information to a relaying server 40 located within a predetermined distance at step S200. Here, the relaying server 40 requests login authentication for the RFID tag 20 by transmitting the received RFID tag information to the home server 10 at step S210.

The home server 10 senses corresponding user information based on the received RFID tag information from the relaying server 40 at steps S220 and S230. If the home server 10 finds any matched information in the sensed user information, the homer server 10 performs login authentication for the corresponding RFID tag 20 at step S240.

After performing the login authentication, the home server 10 transmits a response message to the relaying server 40 at step S250, thereby completing authentication for the user of the RFID tag 20 accessed through the relaying server 40.

The relaying server 40 provides a service access menu after completing the user authentication. Also, if a user requests a predetermined multimedia service, the relaying server 40 applies a call command for the requested multimedia service among a plurality of multimedia services stored in the database 13 at step S260. Here, the relaying server 40 detects service usage information for the requested service among the service usage information stored in the database 13 for the login user at step S270.

The relaying server 40 provides corresponding multimedia services using the detected service usage information at steps S280 and S290. Here, the multimedia service is outputted through the display unit 15 connected to the relaying server 40, such as television set.

When connection to the RFID tag 20 is terminated or a user requests terminating a multimedia service at step S300, the relaying server 40 transmits a service termination event to the home server 10 at step S310.

The home server 10 terminates the multimedia service by performing a logout operation for the login user according to the service termination event at step S320. Here, the home server 10 stores the service usage information for the login user in the database 13 at steps S330 to S350 and transmits a response signal to the relaying server 40 at step S360.

Meanwhile, a multimedia service is provided by the same operation when the relaying server 40 connected to the RFID tag 20 storing external user information accessed the home server 10 through the Internet 50.

That it, the home server 10 performs a user login authentication operation based on usage information received from the relaying server 40 and senses service usage information for a predetermined requested service from the data base 13 for a login user. Here, the home server 10 provides a corresponding service based on the sensed service usage information.

When a user who accesses the home server 10, that is, the relaying server 40, requests service termination, the home server 10 stores the service usage information of the service provided to the login user and releases connection with the relaying server 40 through the Internet 50, thereby terminating the multimedia service.

Although the operations for executing and terminating a multimedia service are embodied in the present embodiments, a multimedia service can be changed to another multimedia service using service usage information of each user stored in the database when a user wants to change a multimedia service to another.

The system and method for providing a multimedia service according to the present invention embody a function for managing services by a user in a Linux based home server and embody a home network environment that supports service mobility according to movement of a user. Therefore, the system and method for providing a multimedia service according to the present invention advantageously enable multimedia contents files stored in a PC or a settop box to be easily shared in the home network environment and provide convenience to users to use the multimedia service.

Also, the system and method for providing a multimedia service according to the present invention store and share multimedia service information, which is provided according to a request of each user, by recognizing and identifying a user using a RFID tag. Therefore, the system and method for providing a multimedia service according to the present invention advantageously provide an event based multimedia service without user interaction.

The foregoing exemplary embodiments and aspects of the invention are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A system for providing a multimedia service, comprising:
a Radio Frequency Identification (RFID) tag; and
a home server for performing a login authentication operation using RFID tag information provided from the RFID tag, storing service usage information of a multimedia service provided for a login user, and providing a corresponding multimedia service based on the service usage information of the multimedia service when a multimedia service is requested again.

2. The system of claim 1, wherein the service usage information of the multimedia service includes at least one of a usage history, playback information, and service time information of the multimedia service provided to the login user.

3. The system of claim 1, wherein the home server further includes a display means for outputting a multimedia service requested by the login user.

4. The system of claim 1, wherein the home server further includes a user information storing means for storing previously registered user authentication information and service usage information corresponding the user authentication information and a service storing means for storing a plurality of multimedia services.

5. The system of claim 4, wherein the home server stores service usage information for the multimedia service provided to the login user in the database when a termination request of the multimedia service is made.

6. The system of claim 1, wherein the home server stores home server accessing information corresponding to the RFID tag information.

7. The system of claim 1, further comprising a relaying server for accessing the home server through a network, receiving a predetermined multimedia service from the home server, and providing the predetermined multimedia service.

8. The system of claim 7, wherein the relaying server accesses the home server based on home server accessing information corresponding to the RFID tag information.

9. The system of claim 7, wherein the home server receives the RFID tag information from the relaying server and performing a login authentication operation of the user based on the received RFID tag information.

10. A method for providing a multimedia service, comprising:
receiving predetermined Radio Frequency Identification (RFID) tag information from a RFID tag;
performing a login authentication operation for a corresponding user based on the received RFID tag information;
detecting service usage information of a multimedia service using user information of a login user when the login user requests the multimedia service; and
providing a corresponding multimedia service based on the detected service usage information of the multimedia service.

11. The method of claim 10, wherein the service usage information of the multimedia service includes at least one of a usage history, playback information, and usage time information of the multimedia service provided to the login user.

12. The method of claim 10, wherein in said providing a corresponding multimedia service, if a usage history corresponding to the requested service is exist, a multimedia service is provided from a previously provided multimedia service based on the playback information and the service time information of the requested service.

13. The method of claim 10, wherein in case of a request for changing the multimedia service to another multimedia service, service usage information corresponding to the login user is stored and the another multimedia service is provided based on service usage information for the another multimedia service.

14. The method of claim 10, further comprising performing a logout operation for the login user and storing service usage information corresponding to the login user in case of a request of terminating the multimedia service.

15. A method for providing a multimedia service, comprising:
receiving RFID tag information from a relaying server connected through a network;
performing a login authentication operation for a corresponding user based on the received RFID tag information; and
providing user information of a login user and corresponding service usage information to the relaying server and providing a multimedia service requested according to the service usage information.

16. The method of claim 15, further comprising: performing a logout operation for the login information and storing service usage information corresponding to the login user when the relaying server requests termination of the multimedia service.
